(19) United States
(12) Patent Application Publication
(10) Pub. No.: US 2016/0205355 A1
(43) Pub. Date: Jul. 14, 2016

(54) MONITORING INSTALLATION AND METHOD FOR PRESENTING A MONITORED AREA

(71) Applicant: Robert Bosch GmbH, Stuttgart (DE)

(72) Inventors: Jan Karl WARZELHAN, Bad Salzdetfurth Ot Heinde (DE); Angelina NOVACHEVA, Hildesheim (DE); Michael HOEYNCK, Palo Alto, CA (US)

(21) Appl. No.: 14/913,798

(22) PCT Filed: Aug. 11, 2014
(86) PCT No.: PCT/EP2014/067140

§ 371 Date: Feb. 23, 2016

(30) Foreign Application Priority Data
Aug. 29, 2013 (DE) 10 2013 217 223.0

(51) Int. Cl. H04N 7/18; G06T 7/00; H04N 9/31; G06K 9/62; H04N 5/225; H04N 5/232; G06T 7/60

(52) U.S. Cl. CPC H04N 7/181; H04N 5/23293; G06T 7/004; G06T 7/60; G06K 9/6201; H04N 5/2257; H04N 9/31

(57) ABSTRACT

Video monitoring installations ensure protection for people at railway stations, airports or in public spaces. Use of the recorded video data allows immediate or subsequent tracking of criminal acts to be implemented or at least supported. A monitoring installation 1 having at least one monitoring camera 4 for recording a monitoring image is proposed, wherein the monitoring image shows a monitored area 5 in surroundings 3, having a second camera 9, 16 for recording a control image 8, wherein the control image 8 shows a control area 13 in the same surroundings 3, wherein the monitored area 5 and the control area 13 at least partially overlap in an overlap area 14, having a portable data processing device 6, wherein the data processing device 6 has a display module 7, wherein the data processing device 6 is designed to display the control image 8 on the display module 7 with an identification 10 for the monitored area 5.

### BACKGROUND OF THE INVENTION

The invention relates to a monitoring installation. The invention furthermore relates to a method for presenting a monitored area using the monitoring installation.

Video monitoring installations ensure protection for people at railway stations, airports or in public spaces. Use of the recorded video data allows immediate or subsequent tracking of criminal acts to be implemented or at least supported.

The debate about the protection of the private sphere and the data security in connection with video monitoring in the public arena is a contentiously discussed topic. In particular, the manufacturers of video monitoring installations always feel obligated to respect that people moving in public places have a great deal of control over the recorded data and therefore make sure that the private sphere of said people is not impaired.

In order to protect said people moving in public places, there are numerous regulations, in particular in Germany, which limit or entirely exclude a use of the video cameras in public places. According to regulations which are in effect at least in Germany, signs must be publicly displayed which make people aware of the monitoring. Nevertheless, the extensive use and the operation of monitoring cameras in the public arena is hampered by the low acceptance of such monitoring by the general population.

A video monitoring system comprising the measures for protecting the private sphere is, e.g., disclosed in the German patent publication DE 101 58 990 C1, which represents the closest prior art.

### SUMMARY OF THE INVENTION

Within the scope of the invention, a monitoring installation is proposed which is suitable and/or designed for monitoring public spaces. The monitoring installation comprises at least one monitoring camera, wherein a plurality of monitoring cameras can also, however, be provided.

The at least one monitoring camera is suited and/or designed to record a monitoring image. The monitoring image shows a monitored area in surroundings. The monitored area is, in particular, the section of the surroundings which is acquired by the recording area (field of view, FOV) of the at least one monitoring camera.

The monitoring camera can be designed as a static camera, the extrinsic camera parameters of which are static, or as a movable, in particular dynamic, camera, the extrinsic camera parameters of which can be changed. The monitoring camera can, for example, be designed as a pan-tilt-zoom (PTZ) camera having extrinsic camera parameters that can be temporally changed. The extrinsic camera parameters are particularly to be understood as the position (X, Y, Z) of the camera, the roll, tilt and sway angle of the camera as well as the focal width of the same. The extrinsic camera parameters particularly comprise all items of information which are required to calculate the recording area and therefore the monitored area of the camera in addition to said camera parameters, such as, e.g., the size of the recording chip, etc.

The monitoring installation comprises a second camera which is designed to record a control image. The control image shows a control area in the same surroundings as the surroundings of the monitored area. The monitored area and the control area at least partially overlap in an overlap area. It is preferred that the at least one monitoring camera and the second camera are directed towards the overlap area from different directions and/or at different distances and/or with different zoom and/or enlargement ratios.

In addition, the monitoring installation has a portable data processing device comprising a display module, such as, for example, a monitor, a display, in particular an LC display, a TFT display or another flat screen.

According to the invention, the data processing device is designed to display the control image on the display module with an identification for the monitored area. The invention particularly claims that the overlap area in the control image is made known by means of the identification.

It is thereby a consideration of the invention that the low acceptance of monitoring installations comprising monitoring cameras, as said monitoring installations are also proposed in the invention, results from the fact that people in the surroundings of a monitored area do not exactly known how the actually monitored area is configured despite signs which for the most part are publicly displayed.

This is due to the uncertainty as to which direction the camera is exactly directed, which lens is used (for example: wide-angle or zoom lens) and if the monitoring camera relates to a movable (PTZ) monitoring camera. The invention has the effect that a person who would like to be informed about the monitored area can as a user have the control image displayed on the portable data processing device, wherein the current or momentary monitored area is made clear by means of the identification. Hence, the user can, e.g., check at any time whether his/her current position belongs to the current monitored area of the monitoring camera or whether he/she as a user is outside of the monitored area.

It is particularly preferred for the data processing device to be designed to display additional items of information about the monitoring with the monitoring camera, which add to or enhance the control image, on the display module. For example, the type of camera (a static or dynamic camera), the intended purpose of the monitoring camera, the technical operator (organization or company that is performing the monitoring), in particular the address of the operator, the party responsible for the monitoring (organization or company which is respectively responsible for the monitoring, such as, e.g., police, fire department, homeland security) and/or the data base, in particular the length of the data storage in days or months, can be indicated. This further provision of information gives the user the option of accessing and presenting additional information about the acquired data of the monitoring camera. If need be, the user can also, e.g., issue a complaint against the acquired data or request said data to be erased on the basis of the additional items of information.

In a preferred embodiment of the invention, the control image can be displayed on the display module in real time and/or can, in particular, be updated as a function of an input of the user. Both versions of the embodiment take into account that the monitored area of the monitoring camera and/or the position of the user can temporally change; thus enabling the monitored area in the control image or the user in the control image to however always be displayed in a timely and/or up-to-date manner. A temporal delay of less than five minutes, preferably of less than one minute and in particular of less than 30 seconds is particularly to be understood by the term “real time”.

In a particularly preferred embodiment of the invention, the second camera is integrated into the portable data processing device. Said portable data processing device is particularly embodied as a cellular telephone, smart phone, tablet PC, PDA, laptop or notebook with camera. In this embodiment, it is thus possible for the user himself/herself to record the control image using the second camera and for the data processing device to then display the identification of the monitored area. This embodiment has the advantage that the user has the option of selecting which part of the surroundings he/she would like to check by means of the control image. In addition, it is, e.g., possible that the user instructs a third person to proceed to the edge of the monitored area and checks whether the person is captured by the monitoring camera or is already outside of the monitored area. In this way, a very high transparency of the monitoring activity of the monitoring installation is presented to the user; thus enabling the acceptance of the monitoring installation to be increased in the general public.

The identification of the monitored area in the control image takes place in a particularly preferred manner by means of an augmentation, wherein the actual control image is enhanced by means of fading in and/or superimposing the identification. This enhancement of the mixed reality, also known as expanded reality, allows the monitored area to be made known, for example, by the display of lines, surfaces, color changes or other virtual objects as identification in the control image. In particular, the actual objects of the control image and the virtual objects of the identification are three dimensionally in relation to each other. The identifications, in particular the virtual objects, are, for example, correctly superimposed onto the control image in terms of geometry and perspective.

In a preferred embodiment of the invention, the monitoring installation comprises an identification module. The identification module is designed to detect an absolute position of the control area in world coordinates. The absolute position comprises in particular the position and the orientation of the control area in world coordinates. The identification module is furthermore designed to set the absolute position of the control area off against an absolute position of the monitoring area in order to produce the identification. The absolute position of the monitoring area is optionally measured or recorded in a planning-related manner. As an alternative or optionally in addition, the position of the monitoring area is determined by the previously mentioned extrinsic and/or intrinsic camera parameters of the monitoring camera. Provided the absolute positions of control area and monitoring area are known in world coordinates, the overlap area can easily be determined and the identification can easily be created.

It is particularly preferred if the identification module is designed to use global position data of the data processing device in order to detect the absolute position of the control area. The position data can especially comprise GPS data, compass data and/or tilt sensor data. By means of the global position data, it is possible to calculate the position of the control area in conjunction with knowledge of the second camera and the extrinsic and/or intrinsic properties thereof.

Provision is made alternatively or as an additional option for the identification module to be designed to use image data of the surroundings and/or the monitored area in order to detect the position of the control area in world coordinates. In this option, a search is, for example, made in the control image by means of extracted image features (for example: SIFT) from image data of the surroundings and/or the monitored area in order to detect the position of the control area.

It is also possible for global position data as well as image data of the surroundings and/or the surrounding area to be used to detect the absolute position of the control area from the identification module.

In an alternative or modified embodiment of the invention, the or a further identification module is designed to detect a relative position of the control area in the surroundings and/or in the surrounding area in order to generate the identification. This embodiment does away with a mathematical detour via the world coordinate system and instead, e.g., uses a local coordinate system or does not use a coordinate system. The detection preferably takes place by means of a comparison between the monitoring image and the control image. Provided compatible image areas are found from the identification module, the overlap area can be determined. On the basis of the detected overlap area, the identification module can produce the identification.

The identification module can itself be optionally disposed in the data processing device or can be designed as a web server, for example in the “cloud” or in the monitoring camera or in a monitoring center. Mixed forms are also possible so that computationally intensive operations, such as a digital image processing, are implemented in a web server; however, the display of the identification in the control image is locally calculated in the data processing device and then implemented.

In a possible modification to the invention, the monitoring installation comprises at least one computer-readable signature, for example: a two-dimensional graphic coding, in particular a QR tag, wherein the signature is disposed in the surroundings and/or in the monitored area and wherein the signature comprises items of information for the monitoring installation. In a particularly preferred manner, the computer-readable signature is designed as a public interface. The items of information particularly comprise an item of contact information for making contact with the monitoring installation. It is thus, for example, possible to transmit a web address by reading in the computer-readable signature, said web address providing further items of information to the monitoring camera and/or the monitoring installation, and/or to form an interface for producing the identification. It is also alternatively possible for, e.g., a wireless data communication link, e.g. a WLAN or WiFi, to be provided, wherein the user is referred to the web address when establishing a connection to the wireless data communication links, in particular to WLAN or WiFi.

In a particularly preferable manner, the monitoring installation comprises a public, freely accessible interface, in particular data interface so that the data processing device can exchange data required for the presentation of the identification and/or the control image with the monitoring installation without access code.

In another embodiment of the invention, the second camera is designed as a separate camera, in particular as a further monitoring camera. In this embodiment, the control image from the separate camera is displayed on the portable data processing device. The identification can be produced by the identification module as previously described. Provision can particularly be made for a piece of information to be given to the second camera by means of the computer-readable signature.

In a further embodiment of the invention, the monitoring installation comprises a projector device for projecting a light identification of the monitored area in the surroundings. In particular, the projector device is integrated into the monitoring camera. Provision is made in a preferable manner for the light identification to be invisible to the human eye. For example, the light identification takes place with light having a waving length >700 nanometers or <350 nanometers. Light in these wave length ranges is however visible for typical cameras; thus enabling the identification to be received as a light identification by the second camera and to be immediately displayed without further computation. Provision can optionally be additionally made for the projector device, in particular the light identification, to be shifted into a visible range in order to make the monitored area visible to the naked human eye, i.e. without any aids. This can, for example, than advantageously take place if a suspicious situation was detected by the monitoring installation in the monitored area.

A further subject matter of the invention relates to a method for presenting the control image comprising the identification of the monitored area on the monitoring installation, as this was previously described and/or according to one of the preceding claims. In the method, the monitoring image and the control image are acquired in a first step. In a further step, the control image comprising the identification of the monitored area is displayed. The method particularly comprises the appropriate use of the monitoring installation as was previously described.

### BRIEF DESCRIPTION OF THE DRAWINGS

Further features, advantages and effects of the invention ensue from the following description of a preferred exemplary embodiment of the invention as well as from the attached drawings. In the drawings:

FIG. 1 shows a schematic layout of a monitoring installation as a first exemplary embodiment of the invention;

FIG. 2 shows a schematic depiction of a first embodiment of the invention;

FIG. 3 shows a second embodiment of the monitoring installation in FIG. 1.

### DETAILED DESCRIPTION

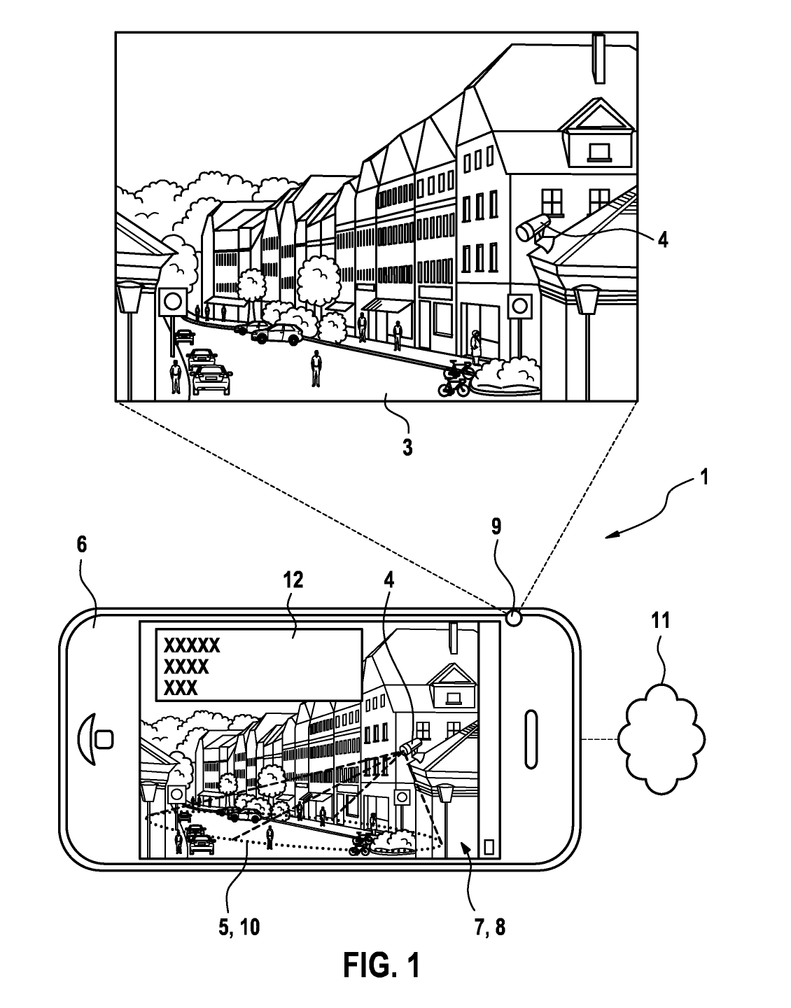

In a schematic illustration, FIG. 1 shows a monitoring installation 1 for monitoring, e.g., public spaces 2, as said spaces are depicted in the real-world scene in the upper portion of FIG. 1. The surroundings can therefore comprise the public space 2 and additionally the rows of houses, people, etc.

A monitoring camera 4 is furthermore shown in the real-world scene, which monitors a monitored area 5 in surroundings 3. The monitored area 5 forms a partial area of the surroundings. The monitored area 5 is, however, not apparent in the real-world scene because the exact orientation of the monitoring camera 4, the focal width thereof and other extrinsic camera parameters cannot be read simply from the presence of said monitoring camera 4.

In the lower region of FIG. 1, a smartphone 6 is depicted as a portable data processing device comprising a display module 7. A control image 8 of the scene in the upper region is displayed on the display module 7 as it may be captured when recorded by means of an integrated camera 9 in the smartphone 6 which is used as a second camera in addition to the monitoring camera 4. As an alternative hereto, the control image 8 is recorded by a further separately disposed camera that is not depicted. The monitoring camera 4 and the smartphone 6 comprising the integrated camera 9 constitute components of the monitoring installation 1.

In the control image 8, the monitoring camera 4 as well as the monitored area 5 is depicted or visualized by superimposing an identification 10 in the form of dashed and dotted lines as virtual objects on the control image 8. This type of depiction is also referred to as augmented reality or mixed reality, wherein virtual objects are shown correctly positioned on the real-world images.

The control image 8 can optionally be depicted in real time and/or augmented in real time or can be regularly automatically up-dated. It is alternatively possible for an active up-dating of the control image 8 and therefore also of the identification 10 of the monitored region 5 to take place. The active up-dating can only be triggered or initiated by the user. The control image 8 comprising the identification 10 can, for example, be up-dated by the user of the smartphone 6 comprising the camera 9 of the smartphone 6 records a further control image 8. Additional items of information 12 to the monitoring by the monitoring camera 4 may optionally be superimposed on the control image 8. The additional items of information 12 can comprise instructions to the operator of the monitoring camera, type of the monitoring camera, etc. and are provided particularly via the network 11. In order to transmit data, which are necessary for depicting the identification 10 and the optional additional items of information 12, the smartphone 6 is connected via a network 11, for example WLAN, WiFi, LTE, Internet, etc.

A user of the smartphone 6 has therefore the possibility to clearly detect which part of the surroundings 3 belong to the monitored area 5. The user is especially transparently made aware as to which area the monitoring camera 4 monitors. In addition to the pure informational function, the acceptance of monitoring installations 1 by the population can be increased in this manner.

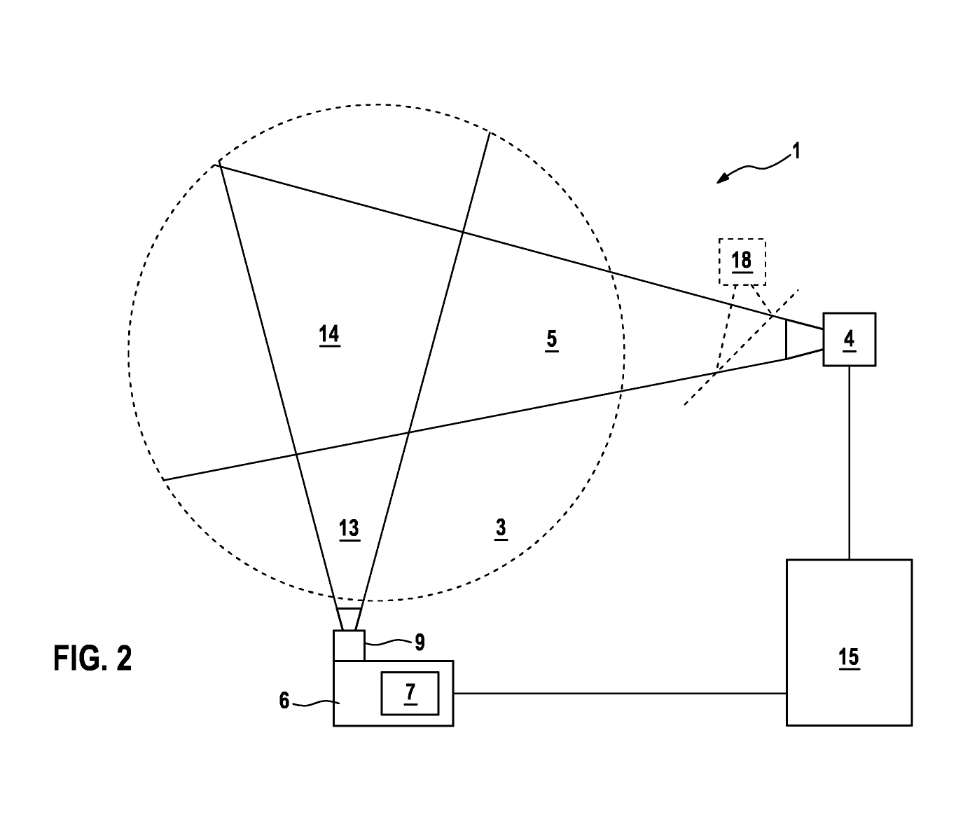

A schematic block diagram of the monitoring installation 1 is shown in FIG. 2. The dashed circle represents the surroundings 3. The area in the surroundings 3 which overlaps with the visual range (FOV: field of view) of the monitoring camera 4 constitutes the monitored area 5. The area of the surroundings 3 which overlaps with the visual range (FOV: field of view) of the camera 9 constitutes the control area 13. The portion of the surroundings 3 which is covered by both the monitored area 5 and the control area 13 constitutes the overlap area 14.

In addition, an identification module 15 is depicted in FIG. 2, which produces the identification 10 in the control image 8. The identification module 15 can constitute an integral component of the smart phone 6. The identification module 15 can additionally be a part of the monitoring camera 4 or a part of another data processing system, such as, e.g., a web server. It is also possible for the functions of the identification module 15 subsequently described to be carried out in a shared manner, wherein one part of the functions is implemented in the smartphone 6, another part of the functions in the monitoring camera 4 and a further part of the functions in the data processing system.

In order to be able to display the monitored area 5 in the control image 8 in the correct position by means of the identification 10, it is necessary to set the monitored area 5 and the control area 13 in relation to one another.

One option consists of calculating the absolute position of the monitored area 5 of the monitoring camera 4 on the basis of extrinsic parameters of the monitoring camera 4, such as the position, orientation, focal width, etc., and in the knowledge of intrinsic parameters of said monitoring camera 4, such as constructive design, size and illumination of the chip, etc., and, for example, of depicting said absolute position of the monitored area 5 of the monitoring camera 4 in world coordinates. This procedure has the advantage that the absolute position is repositioned when a change in the extrinsic parameters occurs, such as, e.g., a pivoting, tilting or zooming of the monitoring camera 4.

The absolute position of the control area 13 and consequently the absolute position of the control image 8 can be calculated on the basis of the global position data received with the smartphone 6, such as, e.g., GPS data, compass data and/or tilt sensor data, and with the intrinsic parameters of the smartphone 6 or the camera 9 integrated into the smartphone 6.

The identification module 15 is designed to compare the two absolute positions of the monitored area 5 and the control area 13, to determine the overlap area 14 and to produce the identification 10 for the control image 8. On the basis of the identification 10 that was produced, the smartphone 6 can present the control image 8 comprising the identification 10 on the display module.

As an alternative to this procedure, it is possible for a relative position of the control area 13 in the surroundings 3 or in the monitored area 5 to be determined by the identification module 15. In this embodiment, image areas from the control image 8 and therefore from the control area 13 in the surroundings 3, in particular in the monitored area 5, are sought in order to be able to establish a relative positioning between the monitored area 5 and the control area 13 and to determine the overlap area 14. The determination of the overlap area 14 occurs especially by means of digital image processing.

As an option, it is possible for artificial markings to be positioned in the surroundings 3 or in the monitored area 5, said markings supporting the mapping of the areas. In this embodiment, it is also possible for a depiction of the monitored area 5 and/or the control area 13 on a world coordinate system to be completely omitted and for only a mapping of the image areas to take place. It is, however, also possible for both measures to be combined with one another in order to increase the evaluation accuracy of the identification module 15. Hence, it is, for example, conceivable that the approximate position of the control area 13 is determined via global position data and that an accurate mapping of the areas occurs by means of a comparison of the image areas in the monitoring image of the monitoring camera 4 with the image areas in the control image 8 of the camera 9.

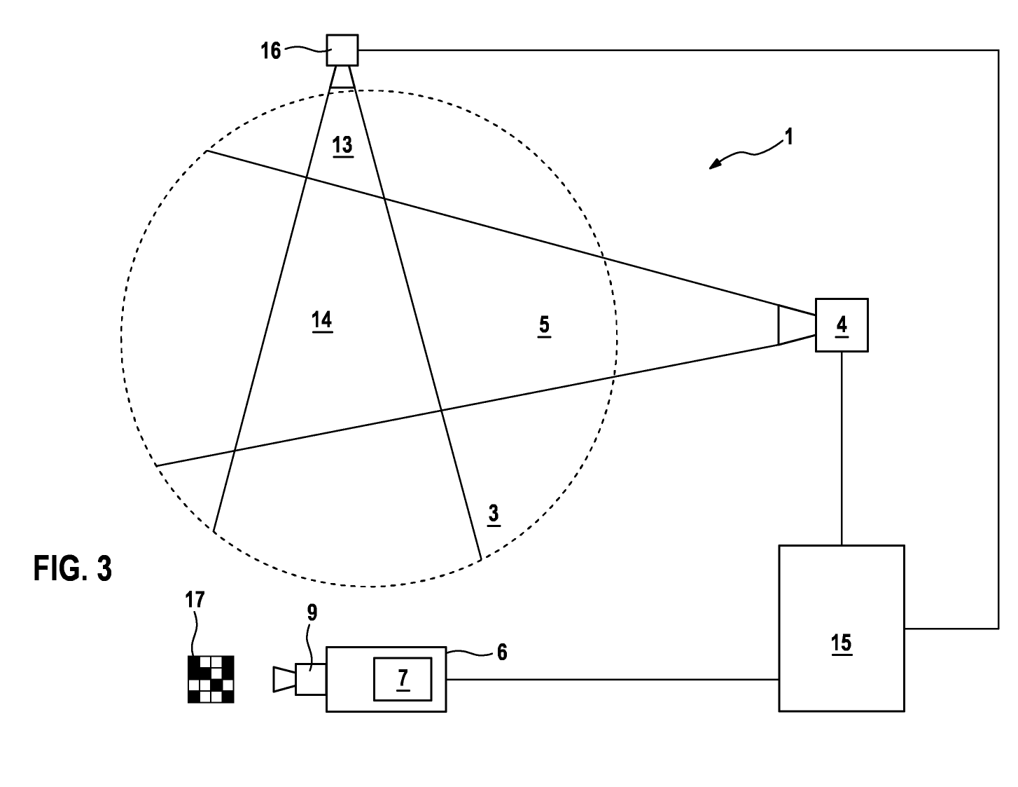

A second embodiment of the invention is shown in FIG. 3, wherein identical parts or identical areas are provided with the same reference sign, wherein reference is made to the explanation of the preceding description. In contrast to the embodiment in FIG. 2, a separate camera 16, e.g. a further monitoring camera, is used as the second camera, wherein the further camera 16 defines the control area 13. As previously described, the overlap area 14 is calculated and the identification is produced in the identification module 15.

The function of the smartphone 6 is limited to a user recording a digital signature, such as, e.g., a QR-Code 17, with the camera and in this way receiving items of contact information with regard to the identification module 15 which transmits the current control image 8 from the further camera 16 comprising the identification 10 to the smartphone 6; thus enabling said smartphone 6 to display the control image 8 comprising the identification 10 on the display module 7. Thus, the control image 8 which is displayed on the smartphone 6 also relates always to a real time image which shows the surroundings 3 with a delay of less than 5 minutes, in particular less than 1 minute, in order to visualize to the user the actual and current monitored area 5.

It should be emphasized that the identification module 15 or the data of the monitoring camera 4 for the identification module 15 is available to the public and can be freely accessed so that every user can use the monitoring installation 1 to display the control image 8 comprising the identification 10.

In the exemplary embodiment in FIG. 2, a projector device 18 can be used instead of the identification module 15, which projects the monitored area 5 by means of a light identification consisting of light which is invisible to the human eye but is visible to the second camera 9 or 16; thus enabling the identification 10 to be formed by the light identification on the display module 7.

1. A monitoring installation comprising:
at least one monitoring camera for recording a monitoring image, wherein the monitoring image shows a monitored area in surroundings,
a second camera for recording a control image, wherein the control image shows a control area in the surroundings, wherein the monitored area and the control area at least partially overlap in an overlap area,
a portable data processing device having a display module and configured to display the control image on the display module with an identification for the monitored area.

2. The monitoring installation according to claim 1, wherein the data processing device is configured to display additional items of information to complement the monitoring with the monitoring camera.

3. The monitoring installation according to claim 1, wherein the control image can be displayed in real time on the display module, can be updated on the display module, or both.

4. The monitoring installation according to claim 1, wherein the second camera is integrated into the portable data processing device.

5. The monitoring installation (1) according to claim 1, wherein the portable data processing device is designed as a cellular phone, smart phone, tablet PC, PDA, laptop or notebook.

6. The monitoring installation according to claim 1, further comprising an identification module for detecting an absolute position of the control area in world coordinates and for setting the absolute position of the control area off against an absolute position of the monitored area in order to produce the identification.

7. The monitoring installation according to claim 6, wherein the identification module is designed to use global position data of the data processing device to detect the absolute position of the control area.

8. The monitoring installation according to claim 1, wherein the identification module is designed to use image data of the surroundings and/or the monitoring area for a comparison with the control image and for detecting the absolute position of the control area.

9. The monitoring installation according to claim 1, wherein the or a further identification module is designed to detect a relative position of the control area in the surroundings, in the monitored area, or both and to produce the identification.

10. The monitoring installation according to claim 9, wherein the identification module is designed to detect the overlap area in the control image.

11. The monitoring installation according to claim 1, wherein the identification module is disposed in the data processing device, is designed as a web service, or both.

12. The monitoring installation according to claim 1, further comprising a computer-readable signature, wherein the signature is disposed in the surroundings, in the monitored area or both and wherein the signature comprises items of information with regard to the monitoring installation.

13. The monitoring installation according to claim 1, further comprising a projector device for projecting a light identification of the monitored area in the surroundings, wherein the light identification is not visible to the human eye and is visible to the second camera, wherein the light identification constitutes the identification.

14. A method for presenting a control image, the method comprising:
recording a monitoring image with at least one monitoring camera, wherein the monitoring image shows a monitored area in surroundings,
recording the control image with a second camera, wherein the control image shows a control area in the surroundings, wherein the monitored area and the control area at least partially overlap in an overlap area,
displaying the control image together with an identification for the monitored area on a display of a portable data processing device.
